(19) United States
(12) Patent Application Publication
(10) Pub. No.: US 2016/0183541 A1
(43) Pub. Date: Jun. 30, 2016

(54) Poultry Cleaning Knife

(71) Applicant: Makare Akhet Aten, Antioch, CA (US)

(72) Inventor: Makare Akhet Aten, Antioch, CA (US)

(21) Appl. No.: 14/832,907

(22) Filed: Aug. 21, 2015

Related U.S. Application Data
(60) Provisional application No. 62/124,694, filed on Dec. 29, 2014.

(51) Int. Cl. A22C 21/00

(52) U.S. Cl. CPC A22C 21/0061

(57) ABSTRACT

The main function(s) of the Poultry Cleaning knife abbreviated (PCK) is for cleaning poultry surface skins.

The Poultry Cleaning Knife scrapes (by gliding) the knife blade across the surface of poultry skin in a downward, continuous, stroking motion. Main parts of the Poultry Cleaning Knife has waved pointed tips to remove aggressive debris and the yellowing coloration that sometimes builds on the top of the surface of poultry skins. The Poultry Cleaning Knife bottom blade performs the same main function that uses a straight line blade for general cleaning of the poultry skins. The bodies of the blade are vents to catch any remaining bacteria and or germs that the top or bottom blades did not remove.

This stroking action of the Poultry Cleaning Knife, removes salmonella, fatty oils, dirt, and debris from the skins of Chicken, Turkey, and any other kind of poultry. The Poultry Cleaning Knife can remove salmonella and other germs from the poultry by a gliding, scraping motion that collects on the blade and can be washed off easily.

Purpose of the Poultry Cleaning Knife is to help remove the amount of salmonella, germs, and oils, from the poultry skins before the poultry is cooked for human consumption.

The Poultry Cleaning Knife is to be utilized to prevent salmonella poising and contamination.

### 1.0

### OVERVIEW

This product specification provides the hardware configuration, external interfaces, capabilities and features of the item, Poultry Cleaning Knife. The information provided in the remaining sections of this document includes a detailed description of the hardware, and external interface architecture of the Poultry Cleaning Knife Drawing. The key features of the drawing/sketch; the parameters that will be used to control, manage, or establish that feature; and the performance characteristics of that feature in terms of outputs, displays, and user interaction.

### 1.2

### GENERAL DESCRIPTIONS

Product Poultry Cleaning Knife is comprised of the following major components:

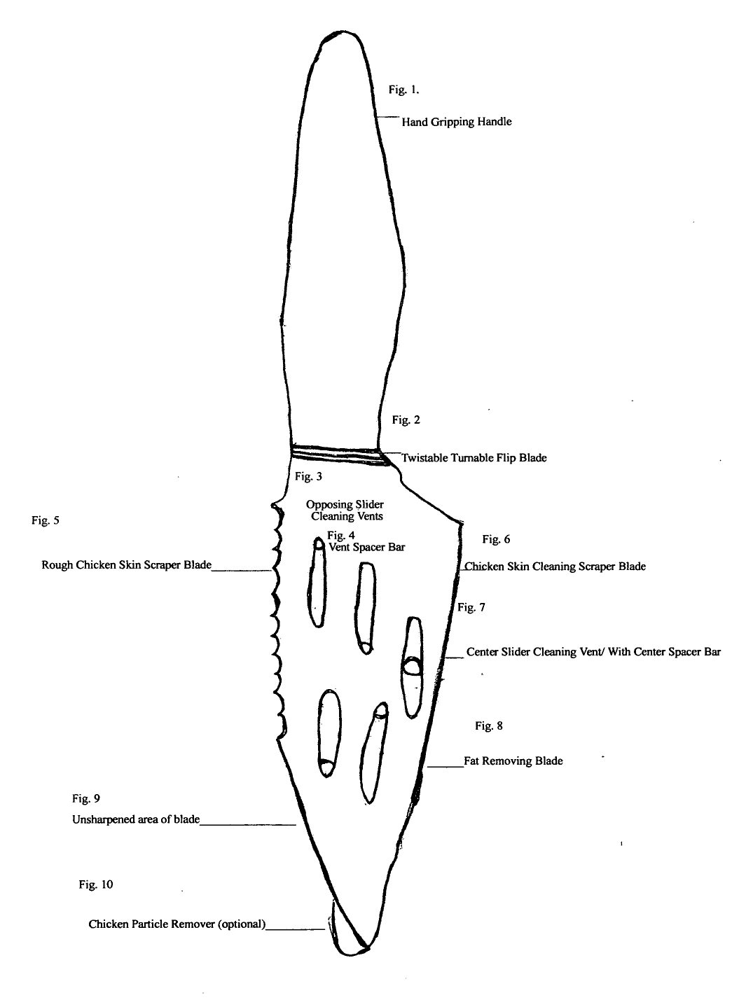

FIG. 1.

Blade Gripping Handle

The Blade Gripping Handle is made of plastic. It is a water proof, comfort grip, hard handle. Provides comfort to the hand with grip groves specifically indented for the hand to support and hold the knife at any angle.

Measures 4.53 inch/11.5 cm.

FIG. 2.

Twistable Turning Flip Blade

This Twistable Flip Blade functions on a turning swivel. The metal swivel is in between the blade and the knife handle.

Blade turns to the aggressive waved multiple point tips that are used for a more aggressive cleaning of poultry cleaning skins.

Blade can also turn to the Center Sliding Scraper Blade. This side of the blade is for general cleaning of poultry skins. This side of the blade also has a function of removing fat from the poultry skins and poultry fat that is underneath skins as included in FIG. 8.

Measures 0.08 inches

FIG. 3.

Opposing Slider Cleaning Vents

The Opposing Slider Cleaning Vents primary function is to catch any bacteria, debris as a second braze behind the scrape of either side of the blade. They are positioned in the body of the blade. There are 4 in number, measuring 1.05 inches.

FIG. 4.

Vent Spacer Bar

The Vent Spacer Bar is positioned as a curved bar at the end of the blade. It is utilized to support the Slider Cleaning Vents.

FIG. 5.

Rough Chicken Skin Scraper Blade

The Rough Chicken Skin Scraper Blade function is to remove salmonella, other bacteria, discoloration such as yellowing and any other debris such as yellowing from the poultry skins. Measures 2 inches from its multiple completion of points. From point to point

It measures 0.17 inches and 0.42 cm.

FIG. 6.

Chicken Skin Cleaning Scraper Blade

The Chicken Skin Cleaning Scraper Blade generally cleans the skins of poultry removing salmonella, fatty oils, and debris from poultry skins. Measures 5.38 inches and 13.67 cm.

FIG. 7.

Center Slider Cleaning Vent/with Center Spacer Bar

The Center Slider Cleaning Vent/With Center Spacer Bar is located in the bottom center of the blade. Its primary function is to catch salmonella and other debris that the Chicken Skin Cleaning Scraper blade did not catch in FIG. 6.

FIG. 8.

Fat Removing Blade

This area of the Fat Removing Blade follows the Chicken Skin Scraper Blade. It has the same primary function as FIG. 6 but is more so used for removing clinging fat from chicken thighs as well salmonella and other debris from poultry skins. Measurements are included as the same in 5.38 inches, 13.67 cm.

FIG. 9.

Unsharpened Area of Blade

Unsharpened Area Of Blade follows the Rough Chicken Skin Scraper Blade. This part of the blade has no primary function and is just a smooth continuation to support the other functions of the blade. Measurements are 2.6 inches.

FIG. 10.

Chicken Particle Remover (Optional)

The Chicken Particle Remover which is an optional function removes guts, veins, etc from the poultry thigh bone. It is a slightly sharpened curved piece. This curved piece that attaches is part of the entire blade.

Measures 0.5 inches.

1. The Poultry Cleaning Knife, and blade scrapes, cleans, and removes bacteria from poultry skin surface including hypodermis of chicken.

2. The Poultry Cleaning Knife blade is a tool used to remove salmonella, oils, fat debris from chicken, and poultry sections.

3. The Poultry Cleaning Knife blade glides over the chicken in a downward motion of continuous strokes, collecting unto the blade bacteria and germs from chicken.
